(19) United States
(12) Patent Application Publication
(10) Pub. No.: US 2015/0072150 A1
(43) Pub. Date: Mar. 12, 2015

(54) POLYMER COMPOSITION CONTAINING A THERMOPLASTIC ELASTOMER, COMPRISING HARD SEGMENTS OF A POLYESTER AND/OR A POLYURETHANE AND SOFT SEGMENTS OF AN ALIPHATIC POLYCARBONATE

(71) Applicant: DSM IP ASSETS B.V., Heerlen (NL)

(72) Inventors: Beert Jacobus Keestra, Echt (NL); Angelika Schmidt, Echt (NL); Agnes Johanna Pauline Björling, Echt (NL)

(21) Appl. No.: 14/389,869

(22) PCT Filed: Mar. 26, 2013
(86) PCT No.: PCT/EP2013/056388

§ 371 Date: Oct. 1, 2014

(30) Foreign Application Priority Data
Apr. 2, 2012 (EP) 12162843.2

(51) Int. Cl. C08L 69/00; H01B 3/42

(52) U.S. Cl. CPC C08L 69/005; H01B 3/426; C08L 2201/02; C08L 2203/202
USPC 428/412; 525/418

(57) ABSTRACT

Polymer composition containing a thermoplastic elastomer, comprising hard segments of a polyester and/or a polyurethane and soft segments of an aliphatic polycarbonate, which composition contains polycarbonate. An insulated wire comprising an insulation layer of the polymer composition.

The invention relates to a polymer composition containing a thermoplastic elastomer, comprising hard segments of a polyester and/or a polyurethane and soft segments of an aliphatic polycarbonate.

Such a polymer composition is known from EP-A-0 846 712. In EP-A-0 846 712 a polymer composition containing a thermoplastic elastomer containing hard segments of a polyester and soft segments of an aliphatic polycarbonate has been described. A thermoplastic elastomer containing such soft segments shows desirable properties, for instance thermo-oxidative resistance, resistance to hydrolysis etc. For this reason the composition is highly suitable for use in inter alia bellows, seals, pipes, hoses and cable insulations.

Despite the desirable properties there is a need for further improvement of the polymer composition, to make the composition more robust for use in the present developed applications, but also to make it possible to use the composition in even more demanding applications than possible with the known composition.

Surprisingly this object is achieved if the polymer composition contains polycarbonate.

The composition shows improved fire retardancy, even without flame retarders, and also improved resistance to abrasion.

Moreover the composition according to the invention shows an improved electrical resistance, which makes the composition highly suitable for the production of cable insulations.

Surprisingly the flexibility of cable insulation of the composition according to the invention at −50° C. is still at an adequate level, despite the presence of polycarbonate in the composition. Also the mechanical properties at very high temperature of the composition (up to 200° C.) are maintained, while polycarbonate has a glass transition temperature far below that temperature.

The composition according to the invention preferably comprises:

(A) 5-95 parts by weight thermoplastic elastomer, comprising hard segments of a polyester and/or a polyurethane and soft segments of an aliphatic polycarbonate,

(B) 95-5 parts by weight polycarbonate,

In one preferred embodiment the composition according to the invention comprises:

(A) 5-50 parts by weight thermoplastic elastomer, comprising hard segments of a polyester and/or polyurethane and soft segments of an aliphatic polycarbonate,

(B) 50-95 parts by weight polycarbonate

Preferably the composition contains 10-40 parts by weight of the thermoplastic elastomer and 60-90 parts of the polycarbonate, more preferably the composition contains 15-30 parts by weight of the thermoplastic elastomer and 70-85 parts by weight of the polycarbonate,

In the most further preferred embodiment the composition according to the invention comprises:

(A) 35-95 parts by weight thermoplastic elastomer, comprising hard segments of a polyester or a polyurethane and soft segments of an aliphatic polycarbonate,

(B) 65-5 parts by weight polycarbonate.

Preferably the composition contains 85-45 parts by weight of the thermoplastic elastomer and 55-15 parts of the polycarbonate, more preferably the composition contains 50-80 parts by weight of the thermoplastic elastomer and 50-20 parts by weight of the polycarbonate.

Preferably the composition contains no further polymers. This means that the polymeric part of the composition according to the invention consists of the thermoplastic elastomer and the polycarbonate.

### Copolycarbonatepolyester Thermoplastic Elastomer

The thermoplastic elastomer containing hard blocks of a polyester and soft blocks of an aliphatic polycarbonate is also referred to as copolycarbonatepolyester thermoplastic elastomer. The copolycarbonatepolyester thermoplastic elastomer used in the composition according to the invention comprises (a) hard segments comprising repeating units derived from an aliphatic diol and an aromatic dicarboxylic acid and (b) soft segments comprising repeating units derived from an aliphatic carbonate.

Suitable aliphatic diols for the hard segments (a) are inter alia alkylene glycols. The number of C-atoms in the alkylene glycol may be between 2-6. Ethylene glycol, propylene glycol and butylene glycol are preferred. Butylene glycol is even most preferred.

Suitable aromatic dicarboxylic acids for the hard segments include isopthalic acid, terephthalic acid, naphthalenedecarboxylic acid and 4,4′-diphenyldicarboxylic acid. Preferably terephthalic acid is used. Most preferably the aromatic dicarboxylic acid in the hard segment consists for at least 80-100 mol. % of terephthalic acid.

The soft segments (b) comprise repeating units derived from an aliphatic carbonate. Suitable aliphatic carbonate units are represented by the formula

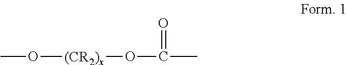

where
R=H, alkyl or aryl,

### X=2-20.

Preferably R=H and x=6, the aliphatic carbonate is therefore hexamethylene carbonate.

The soft segments may also comprise repeating units derived from an aliphatic diol and an aliphatic dicarboxylic acid and/or repeating units derived from a lactone.

The aliphatic diol contains preferably 2-20 carbon atoms, more preferably 3-15 carbon atoms. Most preferably the aliphatic diol is butylene glycol.

The aliphatic dicarboxylic acid preferably contains 2-10 carbon atoms, more preferably 4-15 carbon atoms. Most preferably the aliphatic dicarboxylic acid is adipic acid.

As lactone preferably caprolactone is used.

Preferably at least 40 wt. % of the soft segments consist of the aliphatic carbonate, more preferably at least 60 wt. %, even more preferably at least 80 wt. %, even more preferably at least 90 wt. %, even more preferably at least 95 wt. %, most preferably at least 99 wt. %.

The weight ratio of hard segments and soft segments may be between 20:80 and 90:10, preferably between 30:70 and 80:20, more preferably between 60:40 and 70:30.

One way of producing the copolycarbonatepolyester thermoplastic elastomer is described in EP-A-1 964 871. According to this method polyester and aliphatic polycarbonate diols are reacted in the molten state by transesterification.

The hard segments and the soft segments of the copolycarbonatepolyester thermoplastic elastomer are preferably connected by a urethane group.

Usual difunctional urethane groups are derived from paratoluene diisocyanate, diphenylmethane diisocyanate (MDI), xylylene diisocyanate, hexanethylene diisocyante or isophorone diiscocyanate. A method for producing the copolycarbonateester by connecting the hard and soft segments by a urethane group is described in EP-A-0 846 712.

### Copolycarbonatepolyurethane Thermoplastic Elastomer

The thermoplastic elastomer containing hard segments of a polyurethane and soft segments of an aliphatic polyester is also referred to as copolycarbonatepolyurethane thermoplastic elastomer. The copolycarbonatepolyurethane thermoplastic elastomer may be formed by the reaction between diisocyanates, short chain diols or diamines and the aliphatic polycarbonate as described above. As diidocyanate normally 4,4′-diphenylmethane didiocyanate is used. As short chain diols ethylene diol, 1,4-butanediol, 1,6-hexanediol and 1,4-di-6-hydroxyethoxybenzene are used.

For methods of preparation referred is to Handbook of Thermoplastic Elastomers 2^{nd} edition, Van Nostrand Rheinhold, New York, 1988 (ISBN 0-442-29184-1).

### Polycarbonate

Polycarbonate, also referred to as aromatic polycarbonate is made from at least a divalent phenol and a carbonate precursor, for example by means of an interfacial polymerization process. Suitable divalent phenols that may be applied are compounds having one or more aromatic rings that contain two hydroxy groups, each of which is directly linked to a carbon atom forming part of an aromatic ring. Examples of such compounds are 4,4′-dihydroxybiphenyl, 2,2-bis(4-hydroxyphenyl)propane (bisphenol A), 2,2-bis(4-hydroxy-3-methylphenyl)propane, 2,2-bis-(3-chloro-4-hydroxyphenyl)-propane, 2,2-bis-(3,5-dimethyl-4-hydroxyphenyl)-propane, 2,4-bis-(4-hydroxyphenyl)-2-methylbutane, 2,4-bis-(3,5-dimethyl-4-hydroxyphenyl)-2-methylbutane, 4,4-bis(4-hydroxyphenyl)heptane, bis-(3,5-dimethyl-4-hydroxyphenyl)-methane, 1,1-bis-(4-hydroxyphenyl)-cyclohexane, 1,1-bis-(3,5-dimethyl-4-hydroxyphenyl)-cyclohexane, 2,2-(3,5,3′,5′-tetrachloro-4,4′-dihydroxydiphenyl)propane, 2,2-(3,5,3′,5′-tetrabromo-4,4′-dihydroxydiphenyl)propane, (3,3′-dichloro-4,4′-dihydroxyphenyl)methane, bis-(3,5-dimethyl-4-hydroxyphenyl)-sulphon, bis-4-hydroxyphenylsulphon, bis-4-hydroxyphenylsulphide.

The carbonate precursor may be a carbonyl halogenide, a halogen formate or carbonate ester. Examples of carbonyl halogenides are carbonyl chloride and carbonyl bromide. Examples of suitable halogen formates are bis-halogen formates of divalent phenols such as hydroquinone or of glycols such as ethylene glycol. Examples of suitable carbonate esters are diphenyl carbonate, di(chlorophenyl)carbonate, di(bromophenyl)carbonate, di(alkylphenyl)carbonate, phenyltolylcarbonate and the like and mixtures thereof. Although other carbonate precursors may also be used, it is preferred to use the carbonyl halogenides and in particular carbonyl chloride, also known as phosgene.

The aromatic polycarbonates in the composition according to the invention may be prepared using a catalyst, an acid acceptor and a compound for controlling the molecular mass.

Examples of catalysts are tertiary amines such as triethylamine, tripropylamine and N,N-dimethylaniline, quaternary ammonium compounds such as tetraethylammoniumbromide and quaternary phosphonium compounds such as methyltriphenylfosfoniumbromide.

Examples of organic acid acceptors are pyridine, triethylamine, dimethylaniline and so forth. Examples of inorganic acid acceptors are hydroxides, carbonates, bicarbonates and phosphates of an alkali metal or earth alkali metal.

Examples of compounds for controlling the molecular mass are monovalent phenols such as phenol, p-alkylphenols and para-bromophenol and secondary amines.

Such polycarbonates, their preparation and properties are described in detail in for example Encycl. Polym. Sci. Eng., 11, p. 648-718 (Wiley, New York, 1988) and in Kunststoff Handbuch, 3/1, p. 117-297 (Hanser Verlag, Muenchen, 1992).

The polymer composition according to the invention may further contain one or more of the usual additives, for example processing aids, fillers, UV absorbers, thermal stabilisers, colorants, pigments and flame retarders.

Good results are obtained if the composition does not contain a flame retarder. The composition has intrinsically good fire retardancy and without fire retarders the composition shows further improved properties, for instance mechanical properties and electrical properties.

Examples of applications of the composition according to the invention include tubes, hoses, film and plate.

The composition according to the invention is preferably used as an insulation layer for an electrical wire, especially wires used in transportation vehicles, especially in trains.

Preferably the electrical wire contains an insulation comprising an outer layer and an inner layer, the inner layer being produced form the composition according to the invention. The outer layer may be produced from a composition comprising a thermoplastic polyester elastomer comprising a flame retarder. Preferably a halogen free flame retarder is used, such as phosphinate and a polyphosphate.

### EXAMPLES AND COMPARATIVE EXPERIMENTS

### Materials Used:

Arnitel™ CM 551, a copolycarbonatepolyester thermoplastic elastomer delivered by DSM, the Netherlands.
PC17: an aromatic polycarbonate homopolymer, having a weight average molecular weight of about 17000 g/mol.

### Tests:

### Electrical Resistance

The electrical resistance was determined according to British Standard 3^{rd} Generation (BS3G) 230, test 17 at 95° C., on an American Wire Gauge (AWG) 22 wire. The thickness of the insulation of the wire was 200 microns. The electrical resistance is expressed in MΩ/km.

### Abrasion

The scrape abrasion was determined according to BS3G 230, test 30 on the same wire as referred under electrical resistance. The scrape abrasion is expressed in number of cycles (−) at 120° C. and 1 N load. The target is to achieve >500 cycles.

### Flexibility

The flexibility (cold bend) was determined according to BS3G 230, test 25, at the same wire as referred to under electrical resistance. The wire was stored for 6 hours at −5° C. and wound around a mandrel of 22 times the outer diameter of the wire. The integrity of the wire is checked by applying a high voltage (2.5 kV, for 5 minutes) after immersion of the wire in salt water for 1 hour. Any macro cracks will lead to instant failure, micro cracks lead to failure during the 5 minute period.

### Production of Insulated Wires

Granulate of compositions according to the invention consisting of 100/0, 65/35 and 50/50 wt. % Arnitel CM 551/wt. % PC 17 were produced by using a Coperion™ co-rotating twin screw extruder, having a screw diameter of 25 mm. The output was 20 kg/h, the rotational speed of the screws was 300 rpm.

In the same way a granulate was produced of a flame retardant composition consisting of 70 wt. % Arnitel CM 551, 10 wt. % DEPAL, 5 wt. % MPP and 15 wt. % Böhmit.

Insulated wires were produced by feeding the granulates defined above to a standard extruder for the extrusion of insulated wires using a tooling for pressure extrusion of the insulation and a tooling for tube extrusion of the insulation. The maximum set temperature in the extrusion process was 240° C.

### Comparative Experiment A, B

Insulated wires were produced and tested comprising a single insulation layer of 200 microns of the flame retardant composition. The wires were produced by tube extrusion (comparative experiment A) and pressure extrusion (comparative experiment B). Test results are given in the table.

### Examples I, II, and III

Insulated wires were produced and tested comprising an outer layer of 100 microns of the flame retardant composition and inner layer of 100 microns of the composition consisting of 100/0, 65/35 respectively 50/50 wt. % Arnitel CM 551/wt. % PC 17. The insulated wire with the inner layer of 100/0 wt. % Arnitel CM 551/wt. % PC 17 was produced by tube extrusion, the insulated wires with the inner layer of 65/35 and 50/50 wt. % Arnitel CM 551/wt. % PC 17 were produced by pressure extrusion.

TABLE

| | | electrical | | | |
|---|---|---|---|---|---|
| Example/ | Arnitel/PC | resistance | abrasion | cold bend | |
| Comp. exp. | [wt %/wt. %] | [MΩ/km] | [—] | [pass/fail] | Tooling |
| A | n.a. | 0.028 | 321 | 2pass/1fail | tube |
| B | n.a. | 0.015 | 147 | fail | pressure |
| I | 100/0 | 0.04 | 396 | pass | tube |
| II | 65/35 | 0.16 | 832 | pass | tube |
| III | 50/50 | 1.55 | >1000 | pass | tube |

### Comments on the Results

An increase in electrical resistance, abrasion and cold bend was observed when using the composition according to the invention. The best results were obtained with the composition of 50/50 wt. % Arnitel CM 551/wt. % PC 17. It is very surprising that the compositions according to the invention passed the cold bend test in view of the high amount of polycarbonate in the composition, a rigid polymer.

1. Polymer composition containing a thermoplastic elastomer, comprising hard segments of a polyester and/or a polyurethane and soft segments of an aliphatic polycarbonate, characterised in that the composition contains polycarbonate.

2. Polymer composition according to claim 1, wherein the composition comprises:
(A) 5-95 parts by weight thermoplastic elastomer, comprising hard segments of a polyester and/or a polyurethane and soft segments of an aliphatic polycarbonate,
(B) 95-5 parts by weight polycarbonate.

3. Polymer composition according to claim 1, wherein the composition comprises:
(A) 5-50 parts by weight thermoplastic elastomer, comprising hard segments of a polyester and/or polyurethane and soft segments of an aliphatic polycarbonate,
(B) 50-95 parts by weight polycarbonate.

4. Polymer composition according to claim 1, wherein the polymer composition comprises:
(A) 35-95 parts by weight thermoplastic elastomer, comprising hard segments of a polyester or a polyurethane and soft segments of an aliphatic polycarbonate,
(B) 65-5 parts by weight polycarbonate.

5. Polymer composition according to claim 1, wherein the polymeric part of the composition consists of thermoplastic elastomer, comprising hard segments of a polyester or a polyurethane and soft segments of an aliphatic polycarbonate and the polycarbonate.

6. An insulated wire comprising an insulation layer of the polymer composition as defined in claim 1.

7. An insulated wire according to claim 6, having an insulation comprising an outer layer and an inner layer, the inner layer being produced form the composition according to the invention. The outer layer may be produced from a composition comprising a thermoplastic polyester elastomer comprising a flame retarder.
